(19) United States
(12) Patent Application Publication
(10) Pub. No.: US 2026/0003921 A1
(43) Pub. Date: Jan. 1, 2026

(54) SOCIAL-PLATFORM SPECIFIC CONTENT CREATION USING MACHINE LEARNING

(71) Applicant: GoFundMe, Inc., Redwood City, CA (US)

(72) Inventors: Arnon KATZ, Lafayette, CA (US); David Matthew MURRAY, Thousand Oaks, CA (US); Karan KHURANA, Foster City, CA (US); Patrick Robert SHAMPINE, Los Angeles, CA (US); Ratna SABBINENI, Northlake, TX (US); Eshwar Prasad SIVARAMAKRISHNAN, Somerville, MA (US); Cesar FLORES, Northridge, CA (US); Rowan M. WING, Longmont, CO (US); Ksenia Andreyevna KOZHUKHOVSKAYA, Westminster, CO (US); Charlotte Emily Ann DE WOLFE, Castle Rock, CO (US); Anne Taylor WOOLERY, San Diego, CA (US); Ruslana DALININA, Sebastopol, CA (US); David William F. COBEY, Seattle, WA (US)

(21) Appl. No.: 18/759,543

(22) Filed: Jun. 28, 2024

(51) Int. Cl. G06F 16/9536; G06F 16/9532; G06F 16/9538; G06N 20/00

(52) U.S. Cl. CPC G06F 16/9536; G06F 16/9532; G06F 16/9538; G06N 20/00

(57) ABSTRACT

Systems and methods provide generating social content for social platform. An indication of an event and an indication of a social platform is received from a user device. A query template is selected based on the indicated social platform. A query is generated using the query template which provided as input to a machine learning model. In response, the machine learning model generates a social content, which is provided for display on the indicated social platform.

### TECHNICAL FIELD

This disclosure relates to generative models, and more specifically to techniques for generating content for social media.

### BACKGROUND

Large language models (LLMs) are a type of artificial intelligence system designed to understand generate and manipulate human language. These models are built using deep learning techniques, particularly leveraging neural networks with a large number of parameters, which can process text data and learn intricate patterns in the language.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system according to aspects of the subject technology.

FIG. 3 illustrates an example computing architecture of a server according to aspects of the subject technology.

FIG. 4 illustrates a flowchart of an example process of re-training the machine learning model according to aspects of the subject technology.

FIG. 5 illustrates a flowchart of an example process of generating social content for a social platform.

FIG. 6 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

Social media, text messaging (e.g., SMS) and electronic mail may be used for fundraising campaigns across a wide range of scenarios, from health emergencies to educational initiatives, each benefitting from the support and contribution of multiple individuals. The success of campaigns depends upon reach and engagement with a vast and diverse audience. By leveraging social media platforms, text messaging and electronic mail, campaign organizers can share compelling stories, updates, and calls to action with millions of individual who can be potential donors.

Social media for example, fosters a sense of community and collective effort that is essential for successful campaigns. Social media provides an interactive space where supporters can share their personal messages to encourage others to support, share, and contribute. This interaction not only builds momentum but also adds credibility and authenticity to campaigns. Additionally social media analytics tools allow campaign organizers to track engagement, understand donor demographics and refine their strategies to maximize impact. In essence, social media serves as a powerful amplifier for campaigns, driving visibility, engagement, and contributions in a way that traditional methods simply cannot match.

However, many users initially intend to share personal messages regarding the campaigns on social media platforms (including sharing via text messaging and electronic mail etc.,) but often find themselves unsure of what to say, leading to missed opportunities to garner support. This hesitation can stem from lack of confidence in crafting compelling messages, uncertainty regarding how to convey the urgency or importance of the campaign, or simply not knowing how to start. As a result, even those who are enthusiastic about supporting a cause might struggle to effectively communicate their support, which can significantly limit the campaigns reach and potential contributions. Furthermore, users may not be aware of the most effective way to post social content regarding a given campaign on different social media platforms and therefore may post content that is ineffective and/or suboptimal with regard to driving donors to the campaign.

To overcome this challenge, the subject system can use query templates (or prompt templates) and provide sharing tools designed to make the process easier and to facilitate users in generating social content that is more effective in driving donors to fundraising campaigns. These query templates include clear and concise instructions that can be used to generate queries for LLMs for different social media platforms, text messaging, and electronic mail platforms. They serve as an initial input or guidance that directs the LLM's response, influencing the quality, relevance, and accuracy of the digital content generated by the LLM according to the specifications set by the social media platforms. Without clear prompts the output of the LLM may be too broad or unrelated to the user's needs. The specificity and/or clarity of the query templates may directly impact the precision and/or the relevance of the LLM's responses by narrowing down the vast array of potential outputs. Well-crafted templates ensure that the generated content aligns closely with the desired topic, tone, and style of the user and the campaign. Finally, query templates enhance the efficiency of content creation by minimizing the need for extensive revisions and edits by providing clear and comprehensive instructions for the LLMs to generate content.

The subject system incorporates specific details of the campaigns, preferences of the choice of language and requirements of the social media platforms into the query templates to generate content that is relevant to the user. This customization helps in connecting with particular audiences to maximize fundraising. These templates also play a role in the iterative learning and training of LLMs. The subject system can generate content for different types of campaigns using the LLMs, and gradually refine the LLMs to generate more accurate and relevant content.

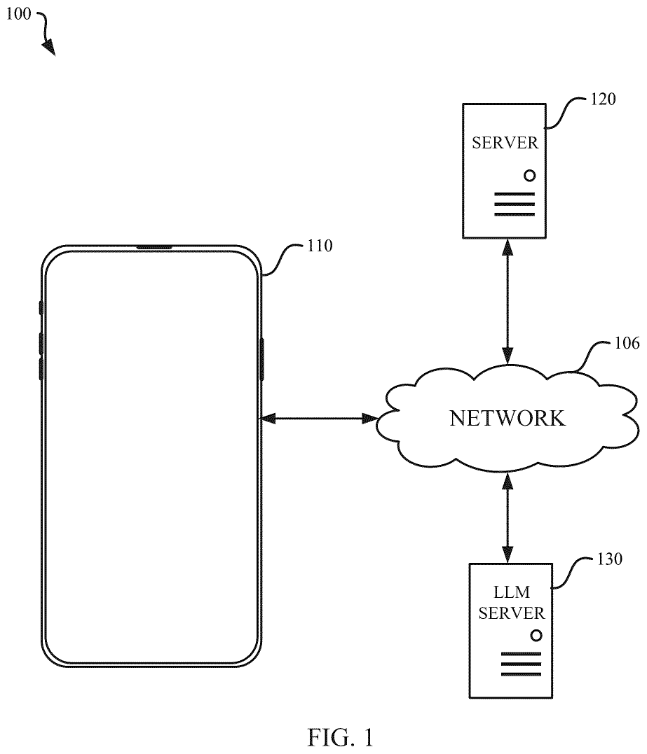

FIG. 1 illustrates an example network environment 100 in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a user device 110 (also referred herein to as an electronic device), a server 120, and a LLM server 130. The network 106 may communicatively (directly or indirectly) couple the user device 110, the server 120 and the LLM server 130. In one or more implementations, the network 106 may be an interconnected network of devices that may include, or may be communicatively coupled to, the Internet. For explanatory purposes, the network environment 100 is illustrated in FIG. 1 as including the user device 110, the server 120 and the LLM server 130; however, the network environment 100 may include any number of electronic devices and any number of servers.

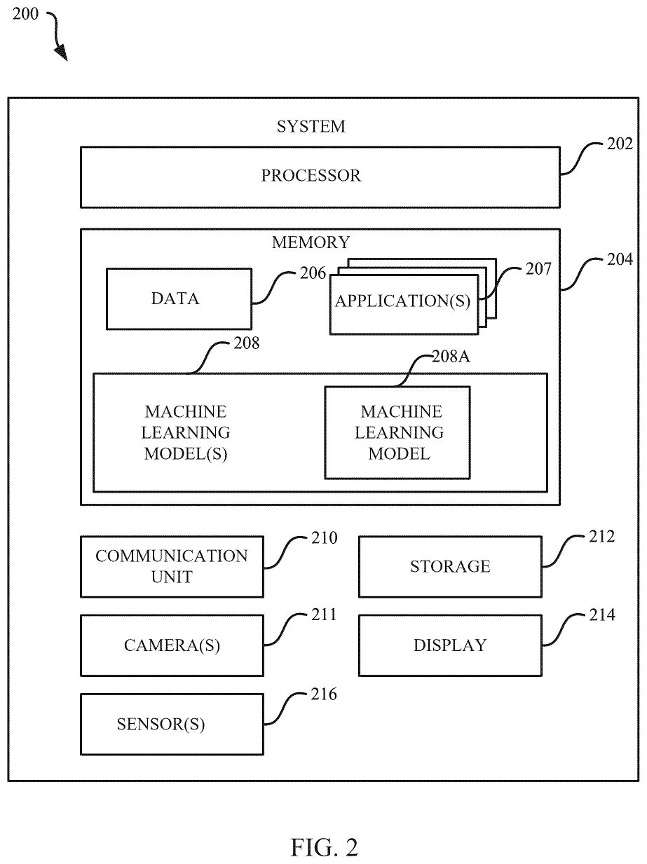

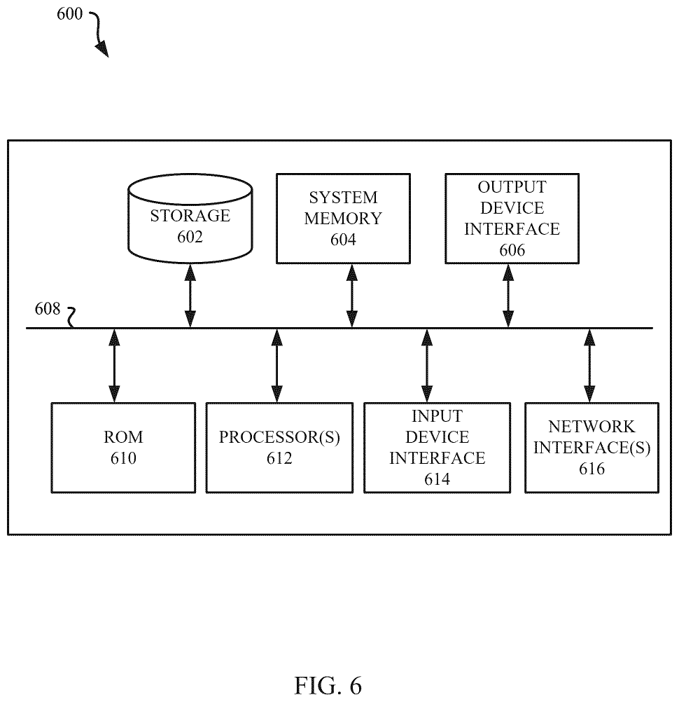

The user device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the user device 110 is depicted as a smartphone. The user device 110 may be, and/or may include all or part of, the systems discussed below with respect to FIG. 2 and/or FIG. 6.

In some implementations, a server 120 and/or the LLM server 130 may provide a platform to train one or more machine learning models for generating digital content. In some implementations, the server 120 and/or the LLM server 130 may provide a cloud service that utilizes the trained machine learning model and is continually refined over time. The server 120 and/or the LLM server 130 may be, and/or may include all or part of, the systems discussed below with respect to FIG. 2 and/or with respect to FIG. 6.

The server 120 can be owned or operated by an entity and may provide a catalog of types of fundraising campaigns, which may be referred to as “events,” detailing various situations that may require collective efforts for resource allocation. These events could encompass a wide range of scenarios, from health emergencies to educational initiatives, each necessitating the support and contribution of multiple individuals. Additionally, the server 120 can be a web server hosting a website that lists all of the events in the catalog. The website allows users to easily create and manage new events providing a user friendly interface for inputting detailed information of the events and track the progress of the events. Moreover, the server 120 is equipped with features that enable users to generate posts for social media platforms making it easier to share event details to reach broader audience. By streamlining the process of event creation and promotion, the server 120 plays a crucial role in ensuring the success of various campaigns and initiatives.

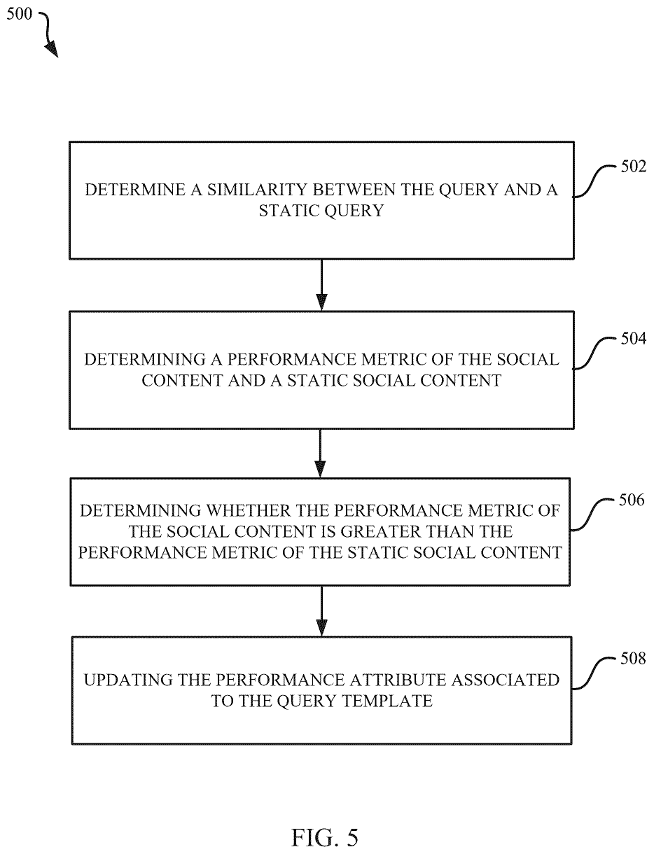

The LLM server 130 can be owned or operated by the entity or a third party technology provider that builds and provides one or more LLMs as a service (LLMaaS). The LLM server 130 may provide a platform to train one or more machine learning models such as LLMs for deployment. In some implementations, the LLM server 130 may provide a cloud service that utilizes the trained machine learning model and is continually refined over time. The LLM server 130 may be, and/or may include all or part of, the systems discussed below with respect to FIG. 2 and/or with respect to FIG. 5.

FIG. 2 illustrates an example system 200 in accordance with some implementations of the subject technology. In an example, the system 200 may be implemented all, or in part, in the user device 110, the server 120 and/or the LLM server 130. In another example, the system 200 may be implemented either in a single device or in a distributed manner in multiple devices, the implementation of which would be apparent to a person skilled in the art.

In an example, the system 200 may include a processor 202, memory 204 (memory device) and a communication unit 210. The memory 204 may store data 206 and one or more machine learning models 208A. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

In an example, the communication unit 210 may include one or more hardware units that support wired or wireless communication between the processor 202 and processors of other computing devices, and/or for communication over a telecommunication network.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 that are currently being executed on the system 200. The one or more applications 207 can interact with each other or with an operating system of the system 200 using application programming interfaces (API) to send or receive data. The one or more applications 207 can also include respective user interfaces (UI) to facilitate user-interaction, enabling the user to provide inputs and receive output seamlessly. For example, when implemented in the user device 110, the system 200 can execute an event sharing application that can provide a UI to receive inputs from the user of the user device 110.

As described above, the server 120 can publish a website to easily create, manage and share events, e.g., fundraising campaigns or other events, providing a user friendly interface for inputting detailed information of the events and track the progress of the events. For example, a user can create an event to highlight a shortage of blood supplies in a local hospital and spread an awareness of a blood drive aimed to collect blood to replenish the blood banks. To create a new event, the user can upload one or more images of the local hospital and update one or more attributes to describe the details of the event. In this example, the one or more attributes can include an event label such as “Community Blood Drive for Local Hospitals,” a time of the blood drive, a date when the blood drive will be organized, a location (e.g., an address) where the blood drive will be organized, details of the blood drive organizers, and instructions for doners.

When the user wants to share the event on a social platform (or via a text messaging and/or an electronic mail platform), the user can use one or more user interface (UI) control elements on the website published by the server 120 to provide instructions to the LLM server 130 to generate social content. For example, the user may be on a portion of the website that displays a description of an event. If the user wants to share the event on a social platform, the user may select an icon indicating and/or identifying the social platform. As for another example, the user can select a label indicating and/or identifying the social platform. In response to the user selection, the user device 110 can transmit the user selection to the server 120. Once the server receives the user selections, the server 120 can initiate the process of generating social content for the user. The following describes the functioning of the LLM server 130 for generating social content for a social platform.

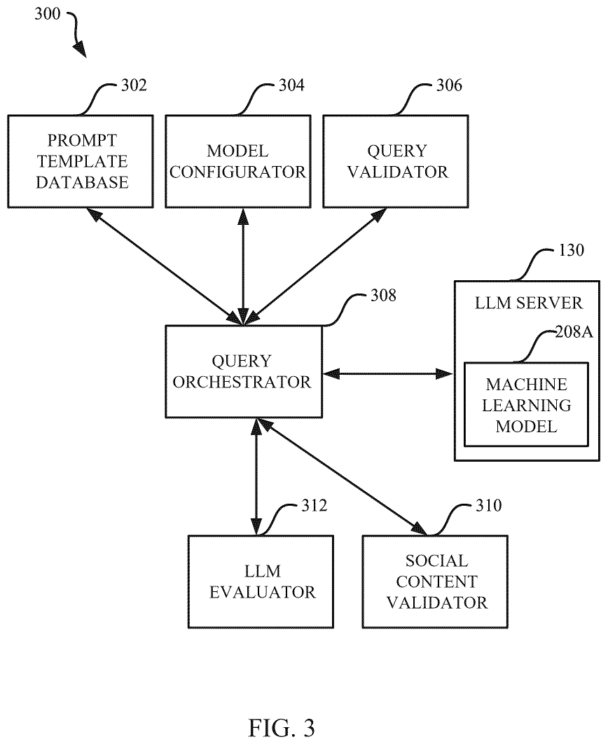

FIG. 3 illustrates an example system 300 in accordance with some implementations of the subject technology. In an example, the system 300 may be implemented in the server 120. In another example, the system 300 may be implemented either in a single device or in a distributed manner in a plurality of devices, the implementation of which would be apparent to a person skilled in the art. For brevity, the following description has been explained with reference to social platforms, the techniques and methods however can be applied to text messaging and/or electronic mail platforms as well.

In an example, the system 300 can include a query template database 302 that can store multiple query templates. A query template is set of instructions for formulating input queries for the ML model 208A. Each query template in the query template database 302 can include multiple placeholders which can be used to insert information regarding the events to generate queries that are relevant to the event.

In an example, the system 300 can include a model configurator 304 responsible for updating and storing one or more settings of the ML model 208 and the LLM server 130. These setting can include a version of the ML model 208, an application programming interface (API) of the ML model 208A, an internet protocol (IP) address of the LLM server 120, a port number for the ML model 208A and/or a Uniform Resource Locator (URL) of the ML model 208A, etc.

In an example, the system 300 can include a query validator 306 that can validate the query generated by the server 120. The query validator 306 can evaluate the query to validate whether the query is safe, efficient, and/or adhering to protocols set by the server 120 and the LLM server 130. In an example, the system 200 can further include a query orchestrator 308 that generates a query based on the query template for the ML model 208A. In an example, the system 300 can include a social content validator 310 to validate the social content generated by the ML model 208A. The social content validator 310 can evaluate the social content generated by the ML model 208A for safety and relevancy. In an example, the system 300 can also include a LLM evaluator 312 that can evaluate the relevancy of the social content on the social platform and the query templates. The LLM evaluator 312 can further initiate a re-training process of the ML model 208A.

In some embodiments, each query template in the query template database 302 includes a set of attributes that are specific to a social platform. These set of attributes may refer to the specifications of the social content that are allowed on the social platform and are unique for each social platform. These set of attributes can include image dimensions, image resolution, length of texts (e.g., number of characters), video resolutions, video frame rate, etc. Since each query template is specific to a social platform, the set of attributes of the query templates can also include a label and/or identifier indicating the social platform. For example, if a query template is specific to a social platform ABC, the value of the attribute indicating the label can be a label “ABC.”

In some embodiments, a social platform can allow the user to configure the specifications of the social content on the social platform. For example, the user can configure the number of characters of text based social content, the resolution of image for image based social content or the frame rate of video based social content for the user's account on the social platform. In such embodiments, the server 130 can query the social platform for the set of attributes that are specific to the user's account on the social platform. In response to receiving the set of attributes from the social platform, the server 120 can update the set of attributes of the query template thereby allowing the user to create social content based on the configuration of the user's account on the social platform.

In some embodiments, the set of attributes associated to a query template may include a performance attribute that includes a value and/or score that reflects the historical performance metric of social content created using the query template on the social platform. For instance, the performance attribute could be a score assigned to a query template based on how well the social content generated using the query template performs on the social platform. For example, if the social content generated using a first query template receives more views or shares compared to social content generated with a second query template, the first template will be assigned a higher score than the second query template.

In some embodiments, the server 120 receives an indication of an event and an indication of a social platform from the user device 110. In response to receiving the indication of the event and the indication of the social platform, the server 120 can initiate a query generation process. In some embodiments, the query orchestrator 308 can select a query template based on the indication of the social platform received from the user device 110. For example, assume that the user intends to share an event on a social platform ABC, the query orchestrator 308 can select a query template that is specific to the social platform ABC. For example, if the indication of social platform received from the user device 110 is a label “ABC”, the query orchestrator 308 can compare the label of the indication with the labels of the query templates and select a query template specific for the social platform ABC.

In some embodiments, the query orchestrator 308 can select a query template based on historical performances of the query templates. To select the query template with the best performance metric, the query orchestrator 308 can utilize the performance attribute associated with each query template. As described before, this attribute reflects the success of past social content generated using the query templates such as the number of views, shares, or other engagement metrics. By evaluating the performance metric, the query orchestrator 308 can select a query template with the best historical performance metric. For example, the query orchestrator 308 can select a query template from the query template database 302, that has a higher score than other query templates. As for another example, the query orchestrator 308 can first select query templates based on the indicated social platform. After selecting query templates that are specific to the indicated social platform, the query orchestrator 308 can select a query template having the highest performance metric score.

In some embodiments, the query orchestrator 308 can select a query template based on type of the identified event. For example, the website published by the server 120 can list multiple event of different types where the type of an event may refer to the purpose of the event. Some of the examples of the event purposes can include medical expenses, memorials and funerals, education and learning, non-profits, and charities, etc. Depending on the type of event, the query orchestrator 308 can select a query template that suits a specific purpose. For example, the set of attributes of each query template can include a label indicating the specific purpose for the respective query templates. While selecting the query template for an event, the query orchestrator 308 can determine the purpose of the event using the label, the description of the event, a title of the event, or one or more tags of the event. The query orchestrator 308 can then select the query template for which the label specifies the same purpose.

In some embodiments, the query orchestrator 308 can obtain one or more settings of the ML model 208 and the LLM server 130 from the model configurator 304. The query orchestrator can include these one or more settings in portions (e.g., placeholders) specified by the query template. These one or more setting can specify the configuration of the ML model 208 that would be used to generate social content. Examples of the one or more settings can include a model identifier of the ML model 208A, a model version of the ML model 208A, an application programming interface (API) specific to the identified model, a destination address of the LLM server 130 which may include an internet protocol (IP) address, URL, port number, etc.

In some embodiments, after selecting the query template and obtaining the one or more settings of the ML model 208A and the LLM server 130, the query orchestrator 308 can use the selected query template, the event description, and the settings of the ML model 208A to generate a query. For example, a query template may specify a first portion (e.g., placeholder) to include the event title, a second portion to include the event description, a third portion to include the one or more settings of the ML model 208A and the LLM server 130. In some embodiments, the query template may further include a portion to include user specific instructions. These user specific instructions can include a message from the user that is provided as input to the website published by the server 120.

In some embodiments, the query orchestrator 308 can use the selected query template to generate a query for the ML model 208A. To generate the query, the query orchestrator 308 can include information corresponding to the event that was previously identified based on the indication of an event received from the user device 110. As described above, the server 120 can host a website that lists all of the events in the catalog. To generate the query, the query orchestrator 308 can obtain one or more details of the identified event, and insert those details into the selected query template. The one or more details of the events can include a label of the event, a description of the event, one or more tags (or labels) associated to the event, one or more images associated to the event, etc. In some embodiments, the query orchestrator 308 can use natural language processing (NLP) to extract one or more feature of the event in case the details of the events are not available. For example, the query orchestrator 308 can use NLP to extract one or more keywords from the label and the description of the events and insert the keywords into the query template.

In some embodiments, after generating the query, the query validator 306 can validate the query to ensure that the inputs are valid, safe, efficient, and adhering to protocols. To validate the generated query, the query validator 306 can for example, check if the generated query is correctly formatted, safe, and likely to produce meaningful and appropriate responses from the ML model 208A. As an example, the query validator 306 can perform a basic validation to check whether the query follows the expected syntax and format specified by the LLM server 130 and/or the ML model 208A. This may include checking for grammatical mistakes, punctuations, and structure of the query. The basic validation may further include validating the length of the query. For example, if the length of the query is less than a pre-specified threshold, the query validator 306 can notify the query orchestrator 308 and in response, the query orchestrator 308 can include additional details of the event to meet the pre-specified threshold.

In some embodiments, the query validator 306 can perform a semantic validation of the query. For example, the query validator 306 can check whether the generated query has clarity and no ambiguity, reducing the likelihood of generating confusing and irrelevant response from the ML model 208A. In some embodiments, the query validator 306 can perform one or more security validations by detecting and mitigating potential injection attacks or harmful inputs that are designed to exploit the vulnerabilities of the ML model 208A. The security validations can also include content validations to remove hate speech and explicit material ensuring that such inputs are not processed by the ML model 208A.

Other validations performed by the query validator 306 can include performance optimization to ensure that the complexity of the query is below a certain threshold so that the ML model 208A can process the query efficiently without overloading the LLM server 130. Other validations performed by the query validator 306 can further include regulatory compliance to ensure that the query meets the relevant regulations and standards such as General Data Protection Regulation (GDPR) for data privacy or specific industry guidelines.

In some embodiments, after validating the query, the server transmits the query to the LLM server 130. After receiving the query from the server 120, the LLM server 130 can uniquely identify the ML model 208A based on the one or more settings of the ML model 208A that was included in the query. After identifying the ML model 208A, the LLM server 130 provides the query as input to the ML model 208A to generate a social content for the indicated social platform. In some embodiments, the social content can be a textual content. However, in other embodiments, the social content can be a multimedia content such as images, videos, emojis, stickers or a combination of different content types. After generating the social content, the LLM server 130 can transmit the social content to the server 120.

In some embodiments, after receiving the social content, the query orchestrator 308 can use the social content validator 310 to validate the social content received from the LLM server 130. The social content validation can include evaluating the social content to ensure quality, safety, and relevance of the social content. For example, the social content validator 310 can perform a semantic validation of the social content to ensure that the social content is relevant and meaningful in relation to the query. This can include a relevancy check to verify that the social content directly addresses the query. The validation query can also include a coherency check to determine whether the social content is logically consistent and follows a coherent narrative.

In some embodiments, the social content validator 310 can perform a syntax and grammar validation to ensure that the social content is free from grammatical mistakes. If the social content validator 310 determines grammatical mistakes in the social content, the social content validator 310 can use grammar correcting tools to remove the errors. In some embodiments, the social content validator 310 can also perform a security validation to determine whether the social content does not include harmful or malicious content. For example, the social content validator 310 can check whether the social content includes hate speech, or objectionable content such as images depicting blood, violence, nudity, etc. If the social content validator 310 determines that the social content includes harmful content, the social content validator 310 can modify the social content to remove the harmful content. For example, if a social content is an image that depicts blood, the social content validator 310 can blur the portion of the image depicting blood. After modifying the social content, the social content validator 310 can again perform the one or more validations described above to ensure quality, safety, and relevance of the modified social content.

In some embodiments, after validating the social content, the server 120 can transmit the social content to the user device 110 for displaying the social content on the user device 110. For example, if the user is on the website published by the server 120, the website can display the social content on the user device 110. If the user approves the social content, using one or more controls of the website, the user device 110 can transmit an indication (e.g., notification) of providing the social content for display on the indicated social platform. In response to receiving the indication for providing the social content for display on the indicated social platform, the website can use an API associated with the indicated social platform to re-direct the user to a website (or an application) of the indicated social platform. In such implementations, the social content is transmitted to the website (or an application) of the indicated social platform and the social content is presented in a preview mode using a UI of the indicated social platform. The user can then provide the social content on the indicated social platform.

In some embodiments, the server 120 can use the LLM evaluator 312 to continuously monitor the performance metric of the social content on the indicated social platform. The LLM evaluator 312 can query the indicated social platform to obtain one or more performance metric such as the number of impressions, the user interactions, click-through rate (CTR), conversion rates, etc. For example, impressions measure the total number of times the content is displayed, while user interactions track direct engagements such as likes comments and shares. CTR indicates the effectiveness of the social content in making users to take actions and conversion rate measures how many users complete a desired action such as donating or signing up for a newsletter after interaction with the social content, etc. In some embodiments, the one or more performance metrics of the social content can also include determining the total funding received in response to sharing the social content on the social platform.

To compare the performance metrics of the query template, the LLM evaluator 312 can evaluate the relevancy of the social content and the performance metric of the social content on the social platform against baseline performance metrics. In some embodiments, the LLM evaluator 312 uses performance metrics of historical queries (referred to as static queries) as a baseline. Static queries can also include queries specifically designed by a system designer (or an admin) of the system 300. The evaluation involves evaluating the performance metrics of the query and the social content against the performances metrics of the static query and the social content generated using the static query (referred to as a static social content). In some embodiments, the static social content can include social content that were historically provided by the users (or provided by the admin) without using the ML model 208A. For example, the static social content for an event can include a user's description (or a message) in support of the event. In some embodiments, the server 130 can also obtain static queries and static social content from multiple users. For example, the server 130 can select a subset of users under a testing program during which the set of users can provide static queries to generate static content from the ML model 208A. By comparing the performance metrics of the social content and static social content, the LLM evaluator 312 can determine the effectiveness of the query template and the ML model 208A.

In some embodiments, the LLM evaluator 312 can determine a similarity between a query template and a static query template. To compute the similarity, the LLM evaluator 312 can process the query and the query template to generate a first embedding. For example, the LLM evaluator 312 can use a neural network that includes multiple neural network layers to process the query and the social content generated using the query to generate the first embedding. Simultaneously, the LLM evaluator 312 can process the static query and the static social content to generate a second embedding. In some embodiments, the first embedding and the second embedding can be vectors in one or more dimensions. To determine a similarity, the LLM evaluator 312 can compare the first embedding and the second embedding to compute a distance (e.g., Euclidean distance) between the first embedding and the second embedding. By doing so, the LLM evaluator 312 can determine a contextual difference between the query and the static query.

In some embodiments, the LLM evaluator 312 can query the indicated social platform to obtain one or more performance metrics of the static social content such as the number of impressions, the user interactions, CTR, conversion rates, etc. The LLM evaluator 312 can compare the one or more performance metrics of the social content and the static social content. For example, the LLM evaluator 312 can compare the conversion rates of the social content and the static social content. If the conversion rate of the social content is greater than the conversion rate of the static social content, the LLM evaluator 312 can determine that the social content is more relevant and accurate than the static social content. In response to the determination, the LLM evaluator 312 can update the performance attribute of the query template by assigning a higher score to the query template. However, if the conversion rate of the social content is less than the conversion rate of the static social content, the LLM evaluator 312 can determine that the social content is less relevant and accurate than the static social content. In response to such a determination, the LLM evaluator 312 can update the performance attribute of the query template by assigning a lower score to the query template.

In some embodiments, the LLM evaluator 312 can generate a score using a scoring model, as a performance attribute of the query template. The scoring model can be a ML model, a scoring algorithm or a rules based model. To generate a score, the LLM evaluator 312 can provide the scoring model with the one or more performance metrics of the social content and the static social content. In addition, the LLM evaluator 312 can also provide the similarity between the first embedding and the second embedding as input to the scoring model. By doing so, the LLM evaluator 312 can compare the relevancy and accuracy of the social content and the static social content based on the contextual differences of the query template and the static query template. The scoring model can process the one or more performance metrics of the social content and the static social content along with the similarity to generate a score for the query template. In response, the LLM evaluator 312 can update the performance attribute of the query template by assigning the generated score to the query template.

In some embodiments, the LLM evaluator 312 can update the performance attribute of the query template based on the accuracy and relevancy of the social content. For example, if the server 120 receives an indication of an event and an indication of a social platform, the server 120 can determine that the user has an intention of generating social content and providing the social content on the indicated social platform. However, after generating the social content, if the server 120 does not receive the indication of providing the social content for display on the indicated social platform (and/or that the user modified the generated social content), the server 120 can determine that the social content was not relevant. In response to such a determination, the LLM evaluator 312 can update the performance attribute of the query template. For example, the LLM evaluator 312 can determine a drop-off rate indicating a percentage of users who initially intended to generate social content and provide the social content for display on the indicated social platform but did not approve the social content. The LLM evaluator 312 can provide the drop-off rate as an input to the scoring model to generate a score for the query template. In response, the LLM evaluator 312 can update the performance attribute of the query template by assigning the generated score to the query template.

In some embodiments, the drop-off rate can also indicate the inefficiency of the ML model 208A in generating high quality social content. In such embodiments, the LLM evaluator 312 can determine to retrain the ML model 208A. To retrain the ML model 208A, the LLM evaluator 312 can create a training dataset that include multiple training samples. Each of the training samples can include a query, a desired social content, a label indicating the social platform, and one or more attributes of the social platform. To re-train the ML model 208A, the LLM evaluator 312 can iteratively process the query, the label indicating the social platform, and the one or more attributes of the social platform. When the ML model 208A generates a social content, the social content is compared to the desired social content to compute a loss value using a loss function. After computing a loss value, the loss value is provided back to the ML model 208A and one or more of the trainable parameters of the ML model 208A are adjusted. The LLM evaluator 312 can repeat the process iteratively using different training samples from the training dataset until the loss value is below a certain pre-threshold. The training process can further include fine tuning that involves adjusting hyperparameters, extending the training duration or enriching the training data set with more diverse examples.

As described before, if the server 120 does not receive the indication of providing the social content for display on the indicated social platform (and/or that the user modified the generated social content) the server 120 can determine that the social content was not relevant. In such embodiments, the LLM evaluator 312 can use the query templates and queries for which the social content was not relevant as training samples of the training dataset. In such embodiments, the LLM evaluator 312 can generate a desired social content for the queries using an alternative ML model. In other embodiments, the desired social content for the queries of the training samples can be generated by humans. After generating the training dataset, the LLM evaluator 312 can re-train the ML model 208A using the training process described above. After re-training, the ML model 208A, the LLM evaluator 312 can use the re-trained ML model 208A to generate an alternative social content.

In some embodiments, if the server 120 receives the indication of providing the social content for display on the indicated social platform (and/or that the user modified the generated social content) the server 120 can determine that the social content was relevant. In such embodiments, the LLM evaluator 312 can use the queries templates and queries for which the social content was relevant as training samples of the training dataset to reinforce a positive feedback into the ML model 208A. In such embodiments, the training samples can include the query, the social content, a label indicating the social platform, and one or more attributes of the social platform. After generating the training dataset, the LLM evaluator 312 can re-train the ML model 208A using reinforcement learning with positive feedback to improve its performance over time.

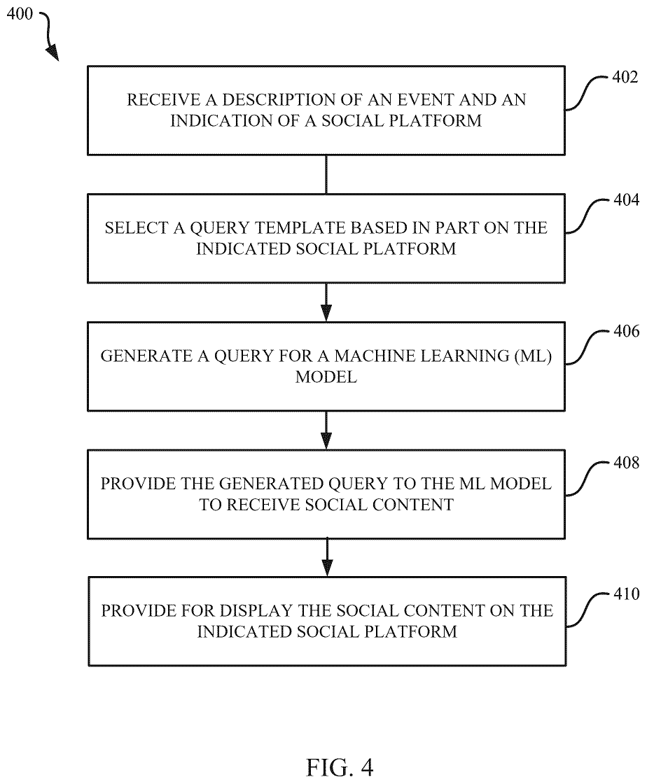

FIG. 4 is a flowchart illustrating an example process 400 of generating social content according to aspects of the subject technology. For explanatory purposes, the process 400 is primarily described herein with reference to the user device 110, the server 120 and the LLM server 130 of FIG. 1. However, the process 400 is not limited to the user device 110 the server 120 and the LLM server 130 of FIG. 1, and one or more blocks (or operations) of the process 400 may be performed by one or more other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the server 120 receives an indication of an event and an indication of a social platform. For example, if the user wants to share an event on a social platform, the user can use one or more user interface (UI) control elements on the website published by the server 120 to provide instructions to the server 120 to generate social content. For example, the user may be on a portion of the website that displays a description of an event. If the user wants to share the event on a social platform, the user may select an icon indicating and/or identifying the social platform. As for another example, the user can select a label indicating and/or identifying the social platform. In response to the user selection, the user device 110 can transmit the user selection to the server 120.

At block 404, the server 120 selects a query template from the query template database. For example, in response to receiving the indication of the event and the indication of the social platform, the query orchestrator 308 of the server 120 can select a query template based on the indication of the social platform received from the user device 110. For example, assume that the user intends to share an event on a social platform ABC, the query orchestrator 308 can select a query template that is specific to the social platform ABC. For example, if the indication of social platform received from the user device 110 is a label “ABC” (or any other unique identifier), the query orchestrator 308 can compare the label of the indication with the labels of the query templates and select a query templates specific for the social platform ABC. The query orchestrator 308 can also select a query template based on historical performances of the query templates. To select the query template with the best performance, the query orchestrator can utilize the performance attribute associated with each query template. For example, the query orchestrator 308 can select a query template from the query template database 302, that has a higher performance score than other query templates. As for another example, the query orchestrator 308 can first select query templates based on the indicated social platform. After selecting query templates that are specific to the indicated social platform, the query orchestrator 308 can select a query template having the highest performance score.

At block 406, the server 120 generates a query for the ML model 208A. For example, the query orchestrator 308 can use the selected query template to generate a query for the ML model 208A. To generate the query, the query orchestrator 308 can include information of the event that was previously identified based on the indication of an event received from the user device 110. As described above, the server 120 can host a website that lists all of the events in the catalog. To generate the query, the query orchestrator 308 can obtain one or more details of the identified event, and insert those details into the selected query template. The one or more details of the events can include a label of the event, a description of the event, one or more tags (or labels) associated to the event, one or more images associated to the event, etc.

At block 408, the server 120 provides the query to the ML model 208. For example, the server 120 transmits the query to the LLM server 130. After receiving the query from the server 120, the LLM server 130 can uniquely identify the ML model 208A based on the one or more settings of the ML model 208A that was included in the query. After identifying the ML model 208A, the LLM server 130 provides the query as input to the ML model 208A to generate a social content for the indicated social platform. After generating the social content, the LLM server 130 can transmit the social content to the server 120. In one or more implementations, an LLM may be hosted locally by the server 120, in which case the query may not be provided to the LLM server 130.

At block 410, the server provides the social content to the indicated social platform. For example, the server 120 can transmit the social content to the user device 110 for displaying the social content on the user device 110. For example, if the user is on the website published by the server 120, the website can display the social content on the user device 110. If the user approves the social content, using one or more controls of the website, the user device 110 can transmit an indication (e.g., notification) of providing the social content for display on the indicated social platform. In response to receiving the indication for providing the social content for display on the indicated social platform, the website can use an API associated with the indicated social platform to re-direct the user to a website (or an application) of the indicated social platform. In response, the social content is transmitted to the website (or an application) of the indicated social platform and the social content is presented in a preview mode using a UI of the indicated social platform. The user can then provide the social content on the indicated social platform.

FIG. 5 is a flowchart illustrating an example process 500 of updating the performance attribute of the query template according to aspects of the subject technology. For explanatory purposes, the process 500 is primarily described herein with reference to the user device 110, the server 120 and the LLM server 130 of FIG. 1. However, the process 500 is not limited to the user device 110 the server 120 and the LLM server 130 of FIG. 1, and one or more blocks (or operations) of the process 500 may be performed by one or more other suitable devices. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, the server 120 determines a similarity between a query and a static query. For example, the LLM evaluator 312 can process the query and the corresponding social content to generate a first embedding. For example, the LLM evaluator 312 can use a neural network that includes multiple neural network layers to process the query and the social content to generate the first embedding. Substantially simultaneously, the LLM evaluator 312 can process the static query and the corresponding static social content to generate a second embedding. As described before, static queries are historical queries that can include queries specifically designed by a system designer (or an admin) of the system 300. The social content generated using the static queries are referred to as static social content. Static social content also includes social content that were historically provided by the users (or provided by the admin.) In some embodiments, the server 130 can obtain static queries and static social content from the users. For example, the server 130 can select a subset of users under a testing program during which the set of users can provide static queries to generate static content from the ML model 208A.

In some embodiments, the first embedding and the second embedding can be vectors in one or more dimensions. To determine a similarity, the LLM evaluator 312 can compare the first embedding and the second embedding and compute a distance (e.g., Euclidean distance) between the first embedding and the second embedding. By doing so, the LLM evaluator 312 can determine a contextual difference between the query and the static query.

At block 504, the server 120 determines a performance metric corresponding to the social content and a static social content. For example, to compare the efficiency of the query template and the ML model 208A, the LLM evaluator 312 can evaluate the one or more performance metrics against baseline performance metrics corresponding to the static queries. The LLM evaluator 312 can query the indicated social platform to obtain one or more performance metrics corresponding to a social content and the static social content. The one or more performance metrics can include a number of impressions, CTR, conversion rates, etc. For example, impressions measure the total number of times the content is displayed, while user interactions track direct engagements such as likes comments and shares. CTR indicates the effectiveness of the social content in causing users to take actions and conversion rate measures how many users complete a desired action such as donating or signing up for a newsletter after interaction with the social content, etc. The one or more performance metrics corresponding of the social content and the static social content can also include a total funding received in response to sharing the social content and the static social content respectively on the social platform.

At block 506, the server 120 determines whether the performance metric corresponding to the social content is greater than the performance metric corresponding to the static social content. For example, the LLM evaluator 312 can compare the conversion rates of the social content and the static social content. If the conversion rate of the social content is greater than the conversion rate of the static social content, the LLM evaluator 312 can determine that the social content is more relevant and accurate than the static social content. However, if the conversion rate of the social content is less than the conversion rate of the static social content, the LLM evaluator 312 can determine that the social content is less relevant and accurate than the static social content.

At block 508, the server 120 updates the performance attribute of the query template. For example, in response to determining that the social content is more relevant and accurate than the static social content, the LLM evaluator 312 can update the performance attribute of the query template by assigning a higher score to the query template. Similarly, in response to determining that the social content is less relevant and accurate than the static social content, the LLM evaluator 312 can update the performance attribute of the query template by assigning a lower score to the query template.

In some embodiments, the LLM evaluator 312 can generate a score using a scoring model. The scoring model can be a ML model, a scoring algorithm or a rules based model. To generate a score, the LLM evaluator 312 can provide the scoring model with the performance metrics corresponding to the social content and the static social content. In addition, the LLM evaluator 312 can also provide the similarity between the first embedding and the second embedding as input to the scoring model. The scoring model can process the performance metrics of the social content and the static social content along with the similarity to generate a score for the query template. In response, the LLM evaluator 312 can update the performance attribute of the query template by assigning the generated score to the query template.

The LLM evaluator 312 can update the performance attribute of the query template based on the accuracy and relevancy of the social content. For example, if the server 120 receives an indication of an event and an indication of a social platform, the server 120 can determine that the user has an intention of generating social content and providing the social content on the indicated social platform. However, after generating the social content, if the server 120 does not receive the indication that the social content was provided for display on the indicated social platform (and/or that the user modified the generated social content), the server 120 can determine that the social content was not relevant. In response to such a determination, the LLM evaluator 312 can update the performance attribute of the query template. For example, the LLM evaluator 312 can determine a drop-off rate indicating a percentage of users who initially intended to generate social content and provide the social content for display on the indicated social platform but did not approve the social content. The LLM evaluator 312 can provide the drop-off rate as an input to the scoring model to generate a score for the query template. In response, the LLM evaluator 312 can update the performance attribute of the query template by assigning the generated score to the query template.

FIG. 6 illustrates an electronic system 600 with which one or more implementations of the subject technology may be implemented. The electronic system 600 can be, and/or can be a part of, server 120, LLM server 130, and/or user device 110 shown in FIG. 1. The electronic system 600 may include various types of computer readable media and interfaces for various other types of computer readable media. The electronic system 600 includes a bus 608, one or more processing unit(s) 612, a system memory 04 (and/or buffer), a ROM 610, a permanent storage device 602, an input device interface 614, an output device interface 606, and one or more network interfaces 616, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a floppy disk, flash drive, and its corresponding disk drive) may be used as the permanent storage device 602. Like the permanent storage device 602, the system memory 604 may be a read-and-write memory device. However, unlike the permanent storage device 602, the system memory 604 may be a volatile read-and-write memory, such as random-access memory. The system memory 604 may store any of the instructions and data that one or more processing unit(s) 612 may need at runtime. In one or more implementations, the processes of the subject disclosure are stored in the system memory 04, the permanent storage device 602, and/or the ROM 610. From these various memory units, the one or more processing unit(s) 612 retrieves instructions to execute and data to process in order to execute the processes of one or more implementations.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to one or more networks and/or to one or more network nodes, such as the user device 110 shown in FIG. 1, through the one or more network interface(s) 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method comprising:
receiving a description of an event and an indication of a social platform;
selecting a query template based in part on the indicated social platform;
generating, using the query template, a query for a machine learning (ML) model based on the description of the event;
providing the generated query to the ML model and, responsive thereto, receiving social content for the event generated by the ML model for the indicated social platform; and
providing, for display on the indicated social platform, the social content generated for the event for the indicated social platform.

2. The computer-implemented method of claim 1, further comprising:
transmitting the social content to a user device for displaying the social content on the user device;
receiving an indication from the user device for providing the social content for display on the indicated social platform; and
updating a performance attribute associated to the query template based in part on a performance of the social content on the indicated social platform.

3. The computer-implemented method of claim 2, wherein updating the performance attribute associated to the query template comprises:
determining a similarity between the query and a static query, wherein the static query is a historical query selected for updating the performance attribute associated to the query template;
determining a performance metric of the social content on the indicated social platform and a performance metric of a static social content on the indicated social platform, wherein the static social content is generated by the ML model using the static query;
determining whether the performance metric of the social content is more than the performance metric of the static social content; and
in response to determining that the performance metric of the social content is more than the performance metric of the static social content:
updating the performance attribute associated to the query template.

4. The computer-implemented method of claim 3, wherein determining the similarity between the query and the static query comprises:
processing the query and the social content to generate a first embedding;
processing the static query and the static social content to generate a second embedding; and
determining a similarity between the first embedding and the second embedding.

5. The computer-implemented method of claim 3, wherein determining the performance of the social content and the performance of the static social content comprises querying the indicated social platform for the respective performances of the social content and the static social content.

6. The computer-implemented method of claim 5, wherein the performance of the social content comprises a number of impressions of the social content on the indicated social platform, a number of user interactions with the social content on the indicated social platform, and a number of times the social content was reused after the user interactions.

7. The computer-implemented method of claim 3, wherein the performance attribute associated to the query template is a score based on the respective performances of the social content, wherein the score is generated using a scoring ML model.

8. The computer-implemented method of claim 2, wherein updating the performance attribute of the query template comprises:
determining that the indication of the social platform was received from the user device;
determining that the indication of providing the social content for display on the indicated social platform was not received from the user device; and
in response to determining that the indication of providing the social content to the indicated social platform was not received from the user device:
determining that the social content was not used for the social content; and
based on the determination, updating the performance attribute of the query template.

9. The computer-implemented method of claim 8, wherein in response to determining that the social content was not used for the social content, retraining the ML model to generate an alternative social content.

10. The computer-implemented method of claim 1, wherein selecting the query template comprises:
querying the indicated social platform for one or more attributes corresponding to the indicated social platform;
receiving, from the indicated social platform, the one or more attributes corresponding to the indicated social platform; and
selecting the query template based in part on the one or more attributes of the indicated social platform.

11. The computer-implemented method of claim 10, wherein the one or more attributes of the social platform comprises a character limit of the social content that is allowed to be displayed on the social platform.

12. The computer-implemented method of claim 1, wherein the ML model is a large language machine learning model (LLM), wherein the LLM is trained to process the query to generate the social content.

13. The computer-implemented method of claim 12, wherein the LLM is trained on a training dataset, wherein the training dataset comprises a plurality of training samples, each training sample comprising the query, the social content, a label indicating the social platform, and one or more attributes of the social platform.

14. A system, comprising:
a processor; and
a memory device containing instructions which, when executed by the processor, cause the processor to:
receiving a description of an event and an indication of a social platform;
selecting a query template based in part on the indicated social platform;
generating, using the query template, a query for a machine learning (ML) model based on the description of the event;
providing the generated query to the ML model and, responsive thereto, receiving social content for the event generated by the ML model for the indicated social platform;
transmitting the social content to a user device for displaying the social content on the user device;
receiving an indication that the social content was provided for display on the indicated social platform; and
updating a performance attribute associated with the query template based in part on a performance of the social content on the indicated social platform.

15. The system of claim 14, wherein updating the performance attribute associated to the query template comprises:
determining a similarity between the query and a static query, wherein the static query is a historical query selected for updating the performance attribute associated to the query template;
determining a performance of the social content on the indicated social platform and a performance of a static social content on the indicated social platform, wherein the static social content is generated by the ML model using the static query;
determining a performance of the social content on the indicated social platform and a performance of a static social content on the indicated social platform, wherein the static social content is generated by the ML model using the static query; and
in response to determining that the performance of the social content is more than the performance of the static social content:
updating the performance attribute associated to the query template.

16. The system of claim 14, wherein updating the performance attribute of the query template comprises:
determining that the indication of the social platform was received from the user device;
determining that the indication of providing the social content for display on the indicated social platform was not received from the user device; and
in response to determining that the indication of providing the social content to the indicated social platform was not received from the user device:
determining that the social content was not used for the social content; and
based on the determination, updating the performance attribute of the query template.

17. A computer program product comprising code stored in a tangible computer-readable storage medium, the code comprising:
code for receiving an indication of an event and an indication of a social platform;
code for selecting a query template based in part on the indicated social platform and a performance metric associated with the query template, the performance metric indicating a historical performance of the query template with respect to the indicated social platform;
code for generating, using the query template, a query for a machine learning (ML) model based on a description of the indicated event;
code for providing the generated query to the ML model and, responsive thereto, receiving social content for the event generated by the ML model for the indicated social platform; and
code for transmitting the social content to a user device for displaying the social content on the user device.

18. The computer program product of claim 17, further comprising:
code for updating a performance attribute associated with the query template based in part on a performance of the social content on the indicated social platform, wherein updating the performance attribute associated to the query template comprises:
code for determining a similarity between the query and a static query, wherein the static query is a historical query selected for updating the performance attribute associated to the query template;
code for determining a performance of the social content on the indicated social platform and a performance of a static social content on the indicated social platform, wherein the static social content is generated by the ML model using the static query;
code for determining a performance of the social content on the indicated social platform and a performance of a static social content on the indicated social platform, wherein the static social content is generated by the ML model using the static query; and
in response to determining that the performance of the social content is more than the performance of the static social content:
code for updating the performance attribute associated to the query template.

19. The computer program product of claim 18, wherein determining the similarity between the query and the static query comprises:
code for processing the query and the social content to generate a first embedding;
code for processing the static query and the static social content to generate a second embedding; and
code for determining a similarity between the first embedding and the second embedding.

20. The computer program product of claim 18, wherein updating the performance attribute of the query template comprises:
code for determining that the indication of the social platform was received from the user device;
code for determining that the indication of providing the social content for display on the indicated social platform was not received from the user device; and
in response to determining that the indication of providing the social content to the indicated social platform was not received from the user device:
code for determining that the social content was not used for the social content; and
based on the determination, code for updating the performance attribute of the query template.
